(19) United States
(12) Patent Application Publication
(10) Pub. No.: US 2020/0380549 A1
(43) Pub. Date: Dec. 3, 2020

(54) INCENTED PLATFORM FOR LONG-FORM CONTENT INCLUDING E-BOOKS, AUDIOBOOK, PODCASTS, AND THE LIKE

(71) Applicant: The Meet Group, Inc., New Hope, PA (US)

(72) Inventor: Geoffrey Cook, New Hope, PA (US)

(21) Appl. No.: 16/889,571

(22) Filed: Jun. 1, 2020

Related U.S. Application Data
(60) Provisional application No. 62/855,212, filed on May 31, 2019.
(60) Provisional application No. 62/855,229, filed on May 31, 2019.

(51) Int. Cl. G06Q 30/02; G06Q 40/04; G06F 16/9535; H04L 29/06; H04L 29/08

(52) U.S. Cl. CPC G06Q 30/0215; G06Q 30/0279; G06Q 40/04; G06Q 30/0231; G06Q 30/0233; G06F 3/04847; G06F 16/9535; H04L 63/08; H04L 67/10; H04L 67/141; G06Q 30/0214; G06Q 30/0235

(57) ABSTRACT

Systems and method relate to incented content consumption and providing a platform for the distribution and consumption of long-form content, such as e-books, audiobooks, podcasts, and the like. Various embodiments may include an application, e.g., Readercoin, that seeks to reward authors and readers of long-form content. Other embodiments include an application, e.g., Podcoin that seeks to reward authors and listeners of long-form audio content. Various applications and platforms discussed herein may be configured to convert reading and listening into currency or other value. Users, authors, etc., may join to earn rewards and generate readers and listeners of their work. Such users may join to earn rewards for their reading and audiobook listening. In other embodiments, certain user actions may earn rewards at an increased rate for meeting a threshold, such a pre-set level of hours.

### CROSS REFERENCE

This application claims priority to U.S. Provisional Application No. 62/855,212, “INCENTED PLATFORM FOR LONG-TERM CONTENT INCLUDING E-BOOKS, AUDIOBOOK, PODCASTS, AND THE LIKE,” filed on May 31, 2019, and U.S. Provisional Application No. 62/855,229, “BUSINESS MODEL FOR INCENTED PLATFORM FOR LONG-FORM CONTENT INCLUDING E-BOOKS, AUDIOBOOK, PODCASTS, AND THE LIKE,” filed on May 31, 2019, which are hereby incorporated by reference in their entirety.

### TECHNICAL FIELD

The present disclosure relates generally to an incented content consumption platform, and more particularly, but not exclusively, to an incented platform for the distribution and consumption of long-form content, such as e-books, audiobooks, podcasts, and the like.

### BACKGROUND

In writing and self-publishing his own book, the present inventor saw first-hand the friction, challenges, and ultimately, the opportunities in the billion-dollar self-publishing market. Unfortunately, large platforms for distributing long form content such as books and audiobooks do nothing to encourage discovery of independent authors. As a result, the vast majority of independent authors have extremely low volume of sales and invest heavily in giveaways and other forms of marketing.

It is important to understand who the self-published author is. They are extremely varied: from the successful business person writing her biography, to the memoir-writing mother, to the bartender working on the next Harry Potter, to the present inventor, and to everyone in between. But they do share something in common. They labored in solitary for hundreds or likely thousands of hours to produce a long-form work which they could not stop working on. They had a hunger to see it completed, and they want people to read it. Only secondarily, do they dream of profits. Many self-published authors call their book-writing hobby “a hole to throw money into.” They price their work to make pennies on every unit sale.

Requiring authors to spend money on giveaways to reach a small number of readers, of which a fraction will rate the book and likely far less will read it, is an unsatisfactory solution. While this may be the cheapest form of marketing available today, it is expensive for the self-published author, and is limiting. As an author, it is simply not possible to giveaway enough books to generate sustained demand.

Making things even harder and more expensive for the self-published author, the fastest growing segment in the book industry today is audio books. The cost of audiobook creation is more than $1500. Self-published authors typically view an audiobook as a bad economic investment that some authors make anyway for vanity reasons, so they can tell their friends their books are available in audio format. Authors are often told to find a professional narrator, and it is very difficult for an author to self-record his or her own audiobook by forcing a high-level of technical knowledge and forcing the author to jump through difficult hoops.

In response to the high cost and extremely low likelihood of success, many self-published authors have shown a willingness to try other platforms that might offer them readership, even if those platforms offer them little or no money. The best example is Wattpad. Wattpad has tens of millions of monthly users reading what most industry professionals would consider poorly written stories. Yet, Wattpad shows alternate reading platforms have value.

Having learned quite a bit about self-publishing from the inside, the present inventor saw some fundamentally interesting mega-trends: the self-published author has no easy or free way to create an audiobook despite the dramatic growth of audio books; the self-published author is hungry for readership and willing to pay for it; the self-published author is open to new platforms. At the same time, creating a utility for audiobook creation is not enough. No platform can reach self-published authors unless they can also deliver on that essential promise: to get them readers, to find them fans, to allow them to become known as the storytellers they know themselves to be.

### SUMMARY

Systems and methods, as discussed herein may comprise computer-based distribution and incentivized consumption of long-form content. Exemplary embodiments of the inventive platform technology include a mobile app-based platform called ReaderCoin, which may be designed for e-books and audiobooks. In another example, a similar platform for podcasts may be implemented. In various examples and embodiments, this platform is referred to as Podcoin. In addition, a model for monetization of the platform is provided.

In various exemplary systems and methods, embodiments may include a server; a database communicatively coupled to the server, the database comprising a plurality of items of long-form content, wherein each item of long-form content in the plurality is associated with an author; a processor; and a memory communicatively coupled to the processor. In embodiments, the memory may store programmatic code such that, execution by the processor causes the computing system to at least: authenticate a connection from a user device to the server, wherein the user device is associated with a consumer of long-form content; obtain, from the user device, a selection comprising an item of long-form content that the consumer selects from the plurality of items of long-form content; establish a connection from an author device to the server, wherein the author device is associated with the author of the selection; display the selection on at least one of an audio interface and a graphical user interface of the user device; send a reward to the user device and to the author device when the consumer consumes the selection.

### BRIEF DESCRIPTION OF THE DRAWINGS

FIG. 1 depicts an interface of a mobile device in accordance with the Readercoin app and other embodiments discussed herein.

FIG. 2 depicts an interface of a mobile device in accordance with the Readercoin app and other embodiments discussed herein.

FIG. 3 depicts an interface of a mobile device in accordance with the Readercoin app and other embodiments discussed herein.

FIG. 4 depicts an interface of a mobile device in accordance with the Readercoin app and other embodiments discussed herein.

FIG. 5 depicts an interface of a mobile device in accordance with the Readercoin app and other embodiments discussed herein.

FIG. 6 depicts another interface of a mobile device in accordance with the Readercoin app and other embodiments discussed herein.

FIG. 7 depicts another interface of a mobile device in accordance with the Readercoin app and other embodiments discussed herein.

FIG. 8 depicts another interface of a mobile device in accordance with the Readercoin app and other embodiments discussed herein.

FIG. 9 depicts an interface of a mobile device in accordance with the Podcoin app and other embodiments discussed herein.

FIG. 10 depicts another interface of a mobile device in accordance with the Podcoin app and other embodiments discussed herein.

FIG. 11 depicts another interface of a mobile device in accordance with the Podcoin app and other embodiments discussed herein.

FIG. 12 depicts another interface of a mobile device in accordance with the Podcoin app and other embodiments discussed herein.

FIG. 13 depicts another interface of a mobile device in accordance with the Podcoin app and other embodiments discussed herein.

FIG. 14 schematically depicts an illustrative embodiment of a technological platform for incentivizing users to consume long-form content.

FIG. 15 is a block diagram depicting the hardware components of a mobile device and the software and data components of various embodiments discussed herein.

### DETAILED DESCRIPTION OF ILLUSTRATIVE EMBODIMENTS

The following detailed description includes a discussion of the ReaderCoin and Podcoin examples, as well as two appendices including additional information concerning the example platforms. It also includes a discussion of a business model for monetization.

Various embodiments discussed herein relate to a computer-based system and method for distribution and incentivized consumption of long-form content. Embodiments may comprise a mobile application, which can communicate with one or more servers and other computer devices across one or more networks to exchange long-form content. Long-form content may comprise e-books, audiobooks, podcasts, music, or other item, such that each item of long-form content is associated with an author.

Communications between the mobile application, operated by one or more users on a computing device (e.g., cell phone), over the various networks to a server may include an authentication to ensure a secure and/or private connection. The user operations may indicate a selection for an item of long-form content, and the selection then prompts a connection between the user device and a computing device associated with the author of the selected long-form content. Such connection may also be secure, occur of the network, and routed through one or more networks, as discussed herein. Upon a grant of access, the user device may display the selection over and audio, visual, or other graphical user interface of the users device. One or more user actions may indicate consumption of the selected content, such actions including one or more of viewing, reading, listening, opening, or otherwise interacting with the selected long-form content. In various examples, consumption may require interaction with the content for a predetermined amount of time, e.g., ten minutes. Such use may be monitored using one or more applications on the user device, such as a timer. Upon consumption of the selected content, a reward may be sent to the user device, with such award being virtual, monetary, or other prize. In other embodiments, a user's consumption of content results in a reward to the author of long-form content.

### Example 1: ReaderCoin

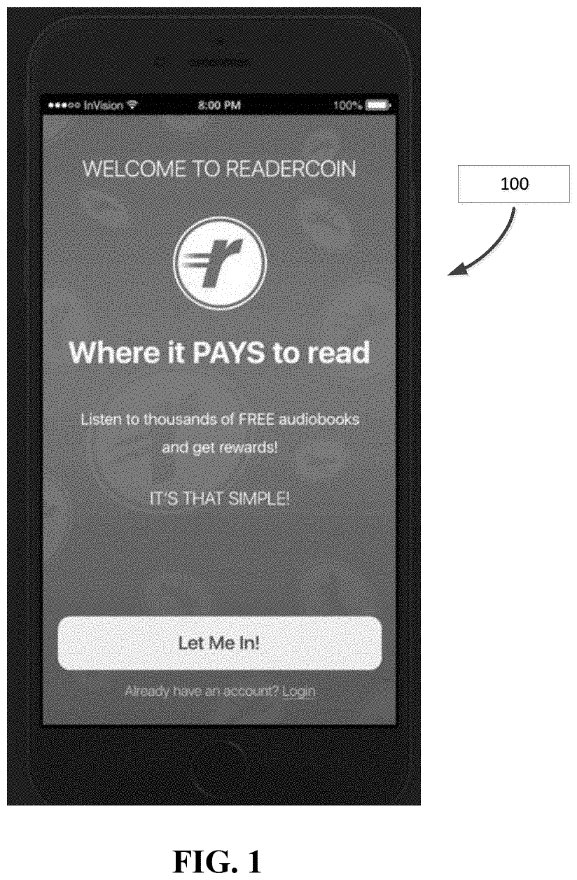

A comprehensive solution to the above described problems in the art may be solved through the examples and embodiments discussed herein. FIGS. 1-9 illustrate aspects of various embodiments, as applied to a computing device, such as a phone, tablet, or other mobile computing device. The depicted mobile application, known as Readercoin, exemplifies various features and improvements as discussed herein, and as applied to a reading application. It will be appreciated that embodiments within the scope of the present invention are not limited to reading and podcast-related applications, and apply to a variety of other fields and subjects in accordance with the systems and methods discussed herein. As illustrated in FIG. 1, ReaderCoin is a mobile application 100 that seeks to accurately and transparently reward authors and readers of long-form content. The application and platform are designed to convert reading and listening into currency.

Readercoin is a radical concept that breaks with so much of mobile and online behaviors. Readercoin incents virtue, not vice. Mobile apps mostly traffic in vices such as vanity, opportunism, or sex. And nearly all of them seek to create habits by “hacking” the human operating system with “login streaks,” “numeric notifiers,” and advanced algorithms to keep their humans logging in, engaging, and ultimately distracted. Readercoin attracts both readers and self-published authors. To do this, the platform may start by paying each constituency for their participation. Because of the difficulty in launching with thousands of self-published titles but no readers, the platform may instead launch with thousands of public domain works, each of which would be available in both audiobook and e-book form so that users can LISTEN TO or READ every story on the platform.

Readercoin, achieves novelty with its simplicity and power of its hook. Such novelty and gamification can encourage people to share and interact with their friends, and promote reading habits and giving to charity. The virtue of the premise reinforces its virality.

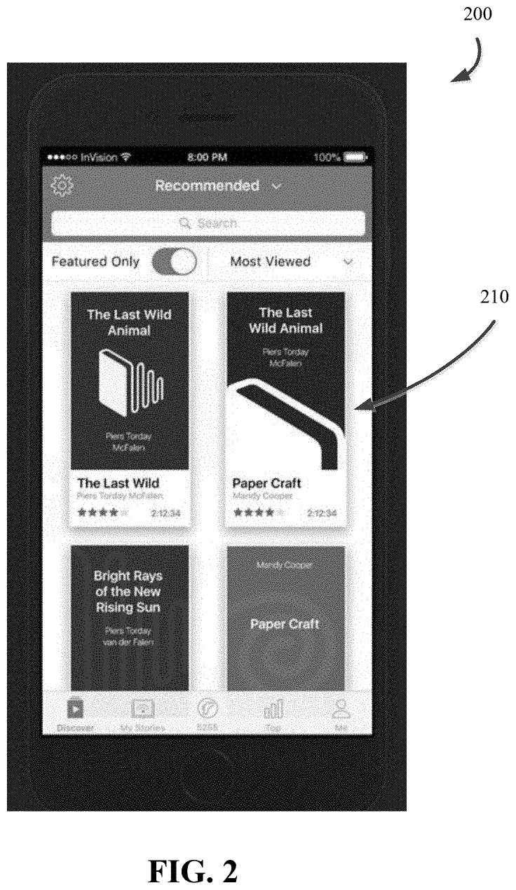

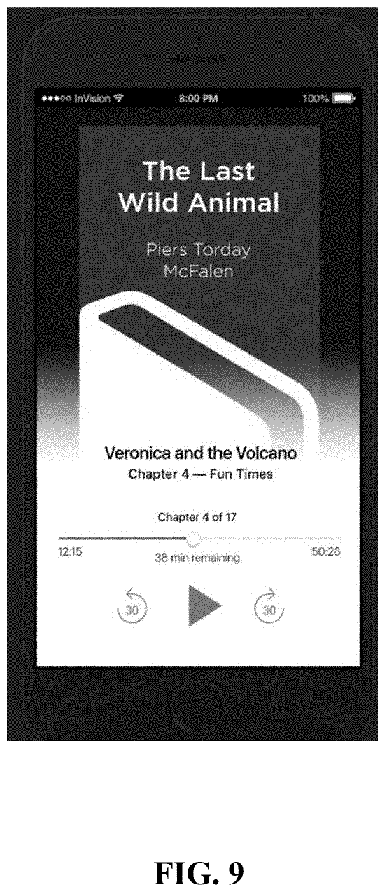

FIG. 2 illustrates an example interface 200, which lists various long-form content 210 available for users. Such content may be books of a variety of forms, e-books, audiobooks, etc., and the interface allows sorting based on one or more filters, such as featured books, most viewed, popularity, recommended, etc. As seen in FIG. 9, content of a book may be displayed as the user is listening to or otherwise interacting with the content. The depicted example illustrates an audiobook, and provides information such as where, in the book, the reader is at, listening metrics, e.g., a time position, and amount of time left in the chapter, and interactive and playback features.

In various embodiments, long-form content may be incentivized to promote interaction or selection from the user. For example, a plurality of items of long-form content may be displayed on the graphical user interface of the user device, for a particular period of time and/or in a particular order, defined by one or more considerations. Such considerations may include an intentional promotion, a paid promotion, based on the user's preferences, settings, or search queries. Promoted long-form content may be delivered to devices at a faster rate than non-promoted content. Such speed variations may encourage selection and consumption of particular items. For example, a selection of the promoted item of long-form, a reward may be sent to the user device and to the author device at a rate that is faster than a rate at which the computing system sends the reward to the user device and to the author device when the selection does not comprise the promoted item of long-form content. In another example, the computing system may send a the reward to the user device and to the author device at the rate that is faster than the rate at which the computing system sends the reward to the user device and to the author device when the selection does not comprise the promoted item of long-form content for a predetermined period of time.

In an embodiment, for example, once the platform has a sustained readership growth, it may charge, rather than pay, authors to access the community of readers. The charge could, e.g., be in the neighborhood of 10 cents per hour of reading time, an order of magnitude cheaper than reaching readers via giveaways. Over time, additional ways to earn revenue may be identified, including working with studios and publishers and identifying promising authors and stories.

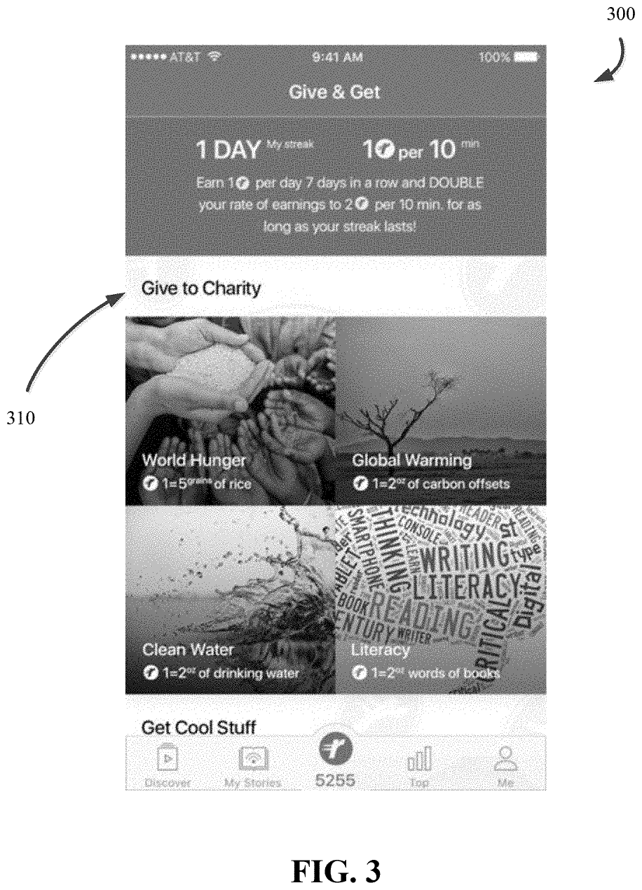

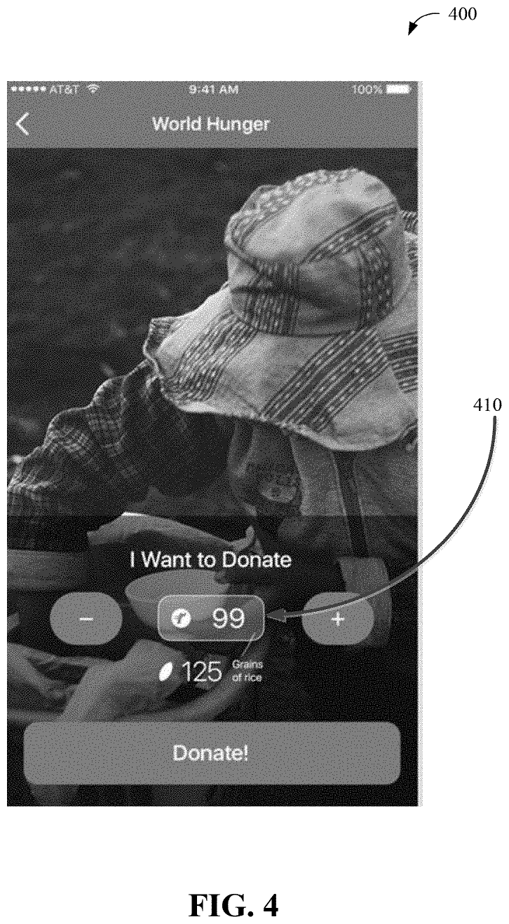

As illustrated in FIG. 3-4, rewards for interacting with and consuming the long-form content can include currency—virtual, monetary, etc.—that can be transferred to an electronic bank account owned by the user, donated to a person or organization (e.g., donating the reward to a charity, crowd-funding project, etc.). FIGS. 3-4, illustrate example interfaces 300, 400 and the methods by which a user may donate earned currency, e.g., virtual coins, to a charity. In the example, a user can browse a variety of organizations and causes to donate coins 310. In examples, a predetermined amount of coins may be given to the user per minutes of use of the application. Users may also select an amount of coins to donate 410 and designate the organization to receive the coins. In the illustrated example of FIG. 4, 99 coins are donated to World Hunger, and the coins are able to buy 125 grain of rice.

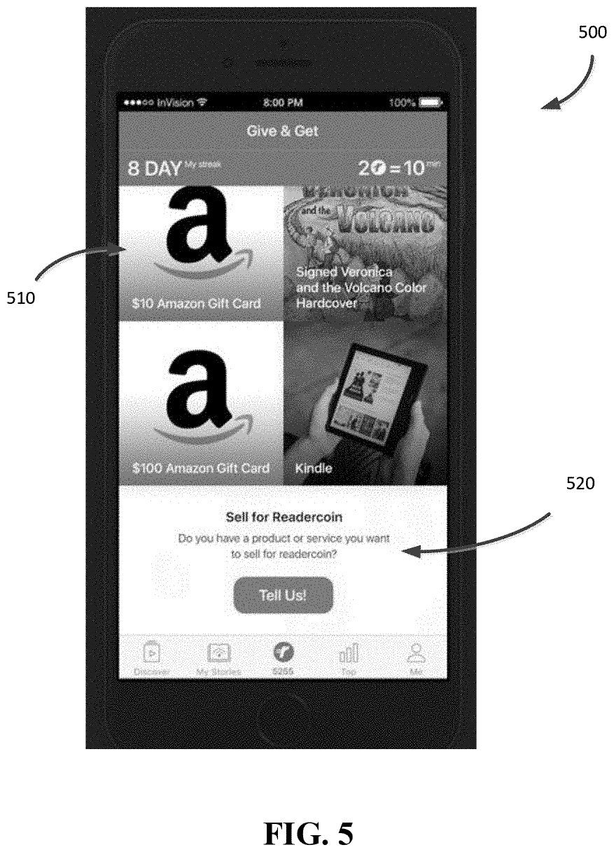

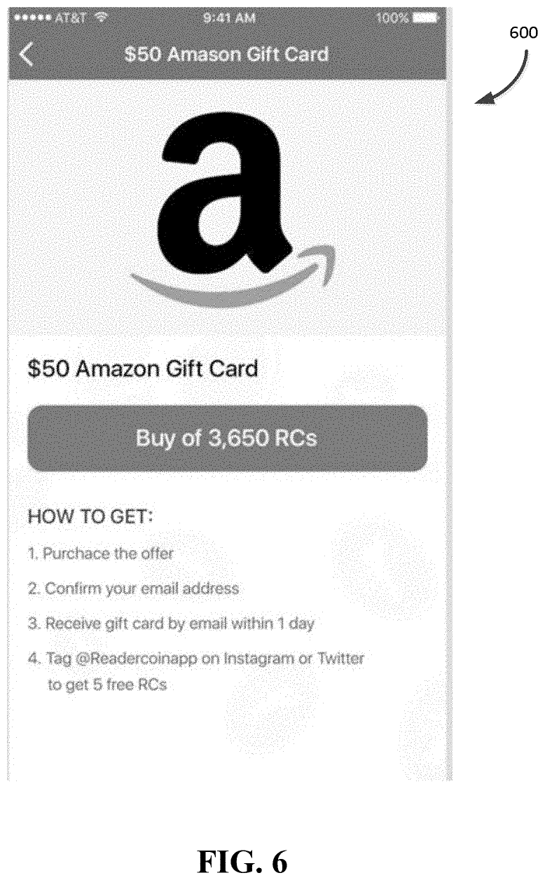

Accordingly, ReaderCoin, and embodiments discussed herein, may reward one or more of users and authors, e.g., by rewarding reading and authorship. FIGS. 5-6 illustrate example incentives and rewards that users—both authors and readers—are offered to help encourage use and interaction with the application. FIG. 5 illustrates offers 510, for gift card, e-reader device, and signed book. In examples, the rewards may be received by exchanging readercoins, which in an example, may be earned based on an amount of time spent using the application. In other examples, rewards and prizes may be received by selling a product or service 520 to readercoin. Such offers may, again, further encourage and incentivize use of the app. FIG. 6 illustrates yet another example wherein 3,650 reader coins may be exchanged for a $50 gift card. It will appreciated, however, that reward may take any of a plurality of items, incentives, and offers, and may be specifically selected toward particular users or groups of users.

Overall, ReaderCoin reflects a number of industry trends, and provides improvements over traditional content distribution and promotion. Readercoin supports long-form content, and promoting both user and consumption of such content. This is a significant improvement over existing user content interactions, which often fracture users' attention, and can make it difficult to promote and sustain interaction. In addition, present embodiments “disintermediate the disinter-mediator.” That is, embodiments help to remove the “gatekeeper”, e.g., large content distributors, and promote the use of long-form content.

Given the rise of mobile reading and audiobooks, the present platform exists in an area of high demand, and even more, allows every book on the platform to be listened to or read. Present embodiments have the potential to be the only destination with huge selection of both e-book and audiobook content on every title.

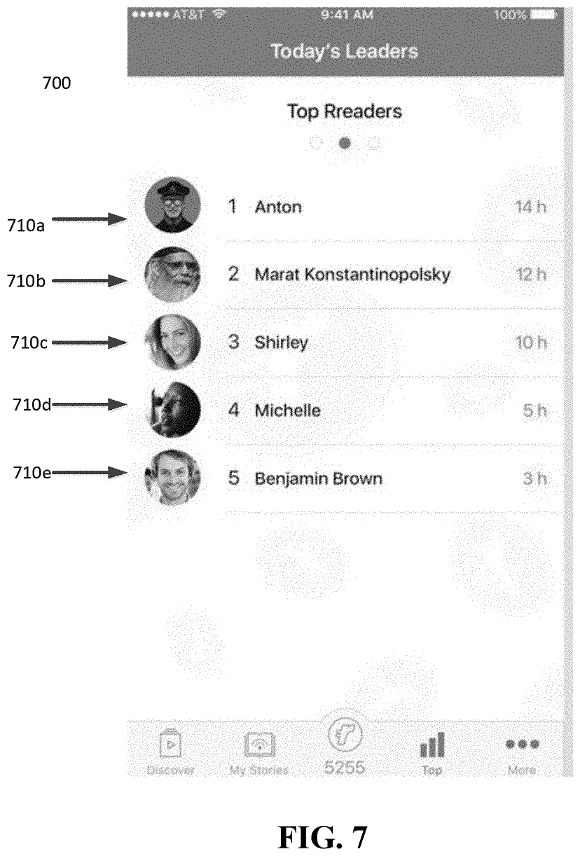

User interfaces and the user experience incorporate a gamification aspect to disclosed systems and methods. In embodiments, as illustrated in FIG. 7, users 710(a)-(e) may interact with each other, and be a part leaderboard 700 related to reading, listening, and spending, wherein top spenders and earners of ReaderCoin are highlighted, promoted, and/or incentivized. Authors may also experience additional promotions, and have access to payment through a variety of methods, including micropayment and cryptocurrency. Royalties, for example, may be powered by micro-payments with goal of eventual cryptocurrency.

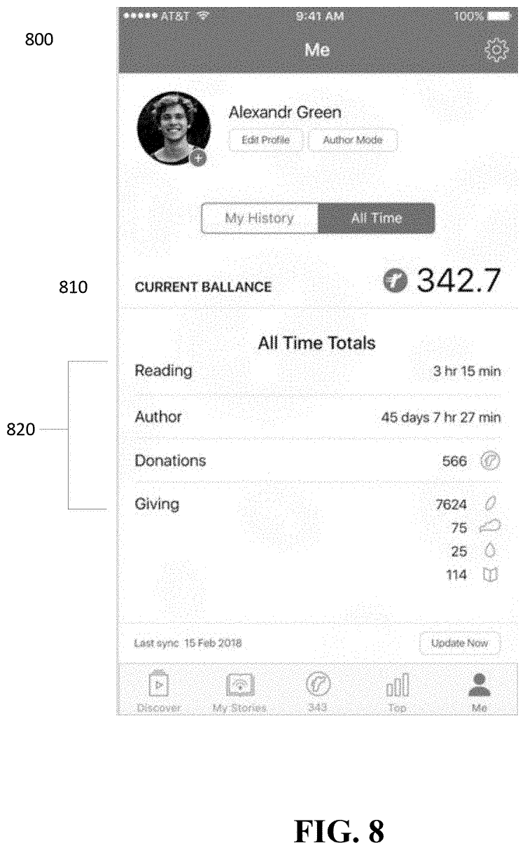

FIG. 8 illustrates an additional aspect wherein users have a profile 800 which gives an overview of the user's use of the application. The profile may illustrate a balance of currency 810, and totals 810 for use of particular actions within the app. Such actions may include an amount of time reading, a number of days as an author, an amount of currency given as donations, and an amount of currency spent on various categories. The profiles may be edited, contain a user image, be visible by other users, and/or display different information depending on a mode of use, e.g., Author Mode.

Various embodiments described herein may incorporate big-data and artificial intelligence methods for scaling, data-driven production, publishing, promotion and discoverability. In some examples, authors may learn the share of readers/listeners who start a chapter and who finish it. Such information can help promote targeted content, alert authors and other users to trends, and help fine-tune the user experience.

In one example, there is the potential to make a networked book, wherein an item of long-form content is editable to a plurality of authors and/or users. Such a feature may enable iterative evolution of the work based on input of early readers and experts. Similarly, books may be crowdfunded through the platform. Readers can vote with their ReaderCoin to support author projects. Authors may also earn engagement-based royalties, wherein authors earn ReaderCoin based on minutes readers spend reading or listening to their work.

Publishing methods may further be improved by systems and methods herein. Various embodiments inherently support serial storytelling, incremental publishing, and serialized fiction. For example, new chapters may be released accordingly to a schedule or when available, and the new content may be automatically distributed to users, e.g., a push notification, to encourage interaction and readership.

Multi-path digital storytelling may be enabled, which would enable, for example, a first-of-a-kind choose-your-own-adventure audiobooks. Additional features may also promote social reading. For example, readers can interact with text, share items, screenshots, portions, excerpts, etc. of long-form content. In some examples, users may tap to hold any line of the book to leave a comment. Users may also engage in group earning of Readercoin for book clubs, schools, etc.

Accordingly, as discussed above, use of Readercoin, and such group earnings may be applied to promote charity. Earned Readercoin currency may similarly be donated to individuals, companies, schools, and charities, such as literacy charities. Likewise, currency earned on the app may be exchanged for cash on various platforms such as PayPal, Venmo, or other bank or transaction medium, and may be exchanged for prizes on one or more platforms.

Various systems and embodiments disclosed herein promote user membership and interaction and in order to, for example, earn rewards for their reading and audiobook listening. Likewise, users will be encouraged to stay due to the large selection of not-available-elsewhere self-published stories available as both audiobook and e-book.

Authors will similarly be incentivized to join in order to earn ReaderCoin and to generate readers and listeners of their work. Platforms and embodiments discussed herein provide an easy, simplified way to create audiobooks and publish contents to users. Moreover, the present embodiments enable self-publishing, and encourage self-published authors by enabling them to get rewarded for their writing. Self-publishing eliminates the need of a middle man and expensive requirements related to book layout, audiobook creation, etc. and allows authors to reach readers in a novel way. Authors will also be incentivized to stay and continue to publish because ReaderCoin is an order of magnitude cheaper than giveaways for promotion and because it is more sustainable than giveaways.

In various examples discussed herein, the present invention may incentivize readers and provide prizes upon content consumption, e.g., interaction. In some examples, a reward may be provided after a predetermined time or interaction, e.g., 10 minutes of reading and/or listening time, the reward being a ReaderCoin token or other currency to the reader and a ReaderCoin token or other currency to the author. Similarly, rewards may be provide to any users for new referrals. Rewards may also be incorporated with external rewards and promotion options. In one example, users may be given an offer to charitably give their rewards, wherein the option includes allowing the reader to convert their reading into grains of rice, ounces of CO2 removal, etc.

Additional information about ReaderCoin, including exemplary depictions, interfaces, and examples are presented in the attached Appendix A

### Example 2: Podcoin for Podcasts

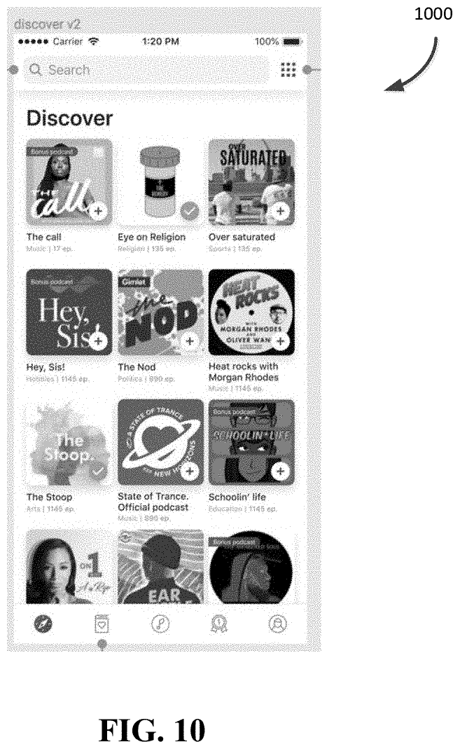

In another example systems and methods disclosed herein may be applied to Podcasts. FIGS. 10-13 illustrate aspects of a podcast-based app, e.g., Podcoin, which shares significant similarities with Readercoin, in terms of functionality, promotions, user/author interaction, user experience, rewards, interface, distribution of content, and incentives. Additional components that may be wholly shared between Readercoin and Podcoin include: registration, mining, balance, the invitation system, rewards tab, leaderboards tabs (with additional distinctions noted below), Top Givers and Top Listener designations, Top Podcasts (similar to Top Books in Readercoin), and a Leaderboard (e.g., “Top Podcasts”, “Top Givers”, “Top Listeners”, etc.)

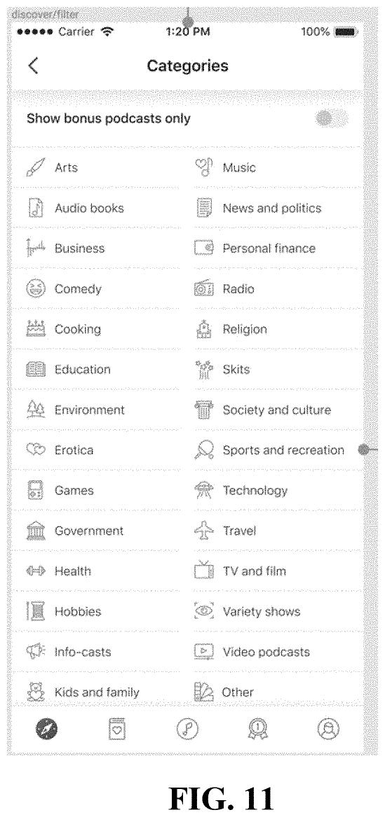

Moreover, various screens and visualizations may exist including but not limited to: Me Tab, Settings Screen, All Global Settings, All Limits, Founder Message, Rewards Mode, and a Player when outside app. FIG. 10 illustrates a “Discover” user interface 1000, which provides suggested content to the user. The suggested content in this example includes a a variety of podcasts which is predicted to be of interested to the user. Such content may be based on one or more factors, including user preferences, past user selections, profile information, machine-learning data, and other methods as discussed herein. Users can also sort, search for and find podcasts based on categories, as illustrated in FIG. 11. In an example, the application may comprise a directory-API to fetch best podcasts, a directory—API to fetch best podcasts by genre when going into category, and search API for search terms and support type-ahead in search box when user pause for 1 second. In some examples, an interaction may include tapping on a podcast in order to fetch metadata for podcast, e.g., episodeIDs to display a screen. Podcasts that are “subscribed” may be added to Library tab for convenient access, and tapping on one opens up the Podcast screen.

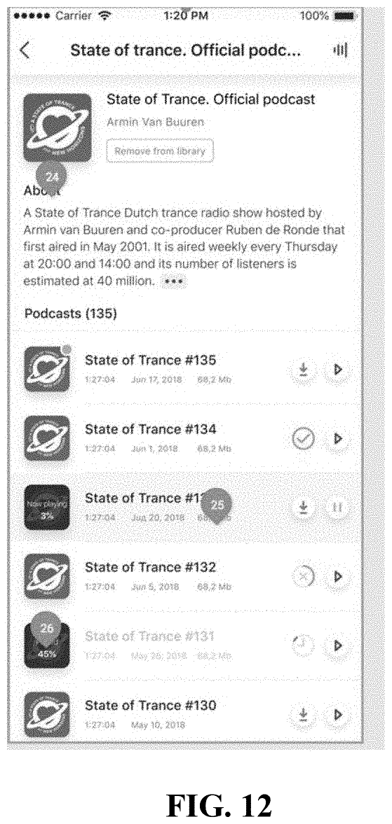

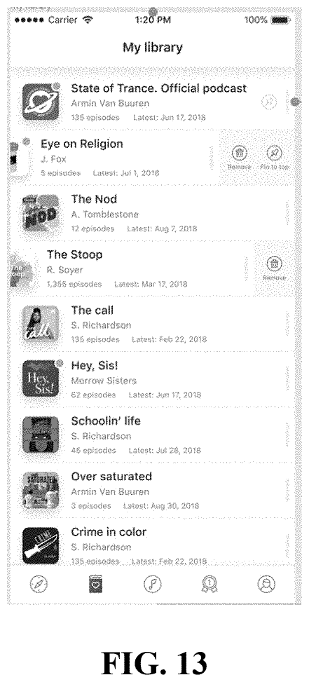

The Podcast screen, an example of which is illustrated in FIG. 12, provides additional details about the podcast. Such details include a description, a listing of episodes, icons for various episodes, playback features, download options, and bookmarking options to add the podcast to the user's library. FIG. 13 depicts an example user library, which lists the various podcasts and episodes that the user has bookmarked, liked, downloaded, saved and/or listened to.

An App Player Screen may also be similar a ReaderCoin player, and/or display some kind of square image. The top right icon on that screen may also provide easy access to the rest of the episodes to play. Outside of App Player Screen, the display may remain unchanged.

In various versions and builds of embodiments discussed herein, features may be added to feature a bonus podcast, enable claiming of a podcast, and displaying podcast stats. In an example, a database table of Podcast IDs that have status of being Claimed and Bonus may be provided. Claimed Podcasts and Bonus Podcasts are separate concepts. Bonus Podcasts may show, for example, up to 6 Bonus Podcasts per major category on each category page and the main page. Then, the bonus podcasts may be displayed at random from available Bonus podcasts. In various examples, bonus podcasts may be repeated in rows (e.g., the first 2 rows and in row 3 for example) and can also be designated with a “Bonus” tag wherever they appear. Claim Podcasts allow users to claim a podcast. Various display screens may also display podcast stats for owners/authors, e.g., total viewers, timing, interaction, rating, etc. Push Notifications can also be provided between the owner/author to the listener, and when new podcasts are published.

In yet another example, various embodiments may enable the building of a social profile, and allow following of users/authors. Users/authors may searched for by a user name and followed. Top-followed authors and podcasts may be followed, and podcasts may be sorted by category. Similarly, episodes of podcasts may be ranked in a similar manner.

Various embodiments also include the use of badges, which can indicate a particular level of use. For example, animations, figures, avatars, notifications, rewards etc., may be provided for achieving milestones. Such milestones may, for example, be related to giving, overall use, listening, and so forth.

Users may also be given an ability to like and comment with other users and/or content provided on the app. For example, a like button on audio player screen for episodes may be selected to endorse, condemn, or otherwise reach to a piece of long-form content. Such rating may be pushed to followers, and/or shared publicly, e.g., when a user likes or rates a new podcast episode subject to rate limit. Some podcast screens may also have a spot for comments. Owners can delete comments on their content. Messages and other notifications may also be pushed owners and users when new comments are left. Likewise, messages may be pushed to followers and those directly messaged or tagged when a comment is left.

Additional information, including various screenshots and graphical user interface examples about Podcoin is presented in the attached Appendix B.

Platform Technology

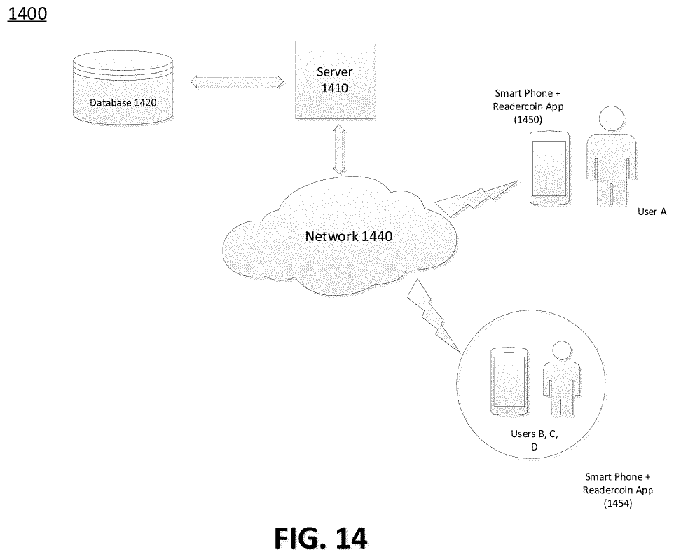

FIG. 14 depicts an illustrative embodiment of a platform 1400 in accordance with the present invention. As shown, the platform 1400 includes a server computer 1410, which we call the “Incented Platform” server. The server 1410 is coupled to a database 1420 and to a network 1440 as a web service. In this way, the Incented Platform server 110 may be communicatively coupled with the user's smart phone including the “Readercoin” user app 1450, which in this example is used by a person we call “User A”. The Incented Platform server 1410 may also be communicatively coupled with the user's smart phone including the “Podcoin” user app, which in this example is used by a person we call “User A”. One or more additional users of the app 1454 may also be included on the platform 1400. In this illustration, the additional users 1454 (whom we call User B, User C, User D, etc.) are assumed to be additional users of the Readercoin user app or the Podcoin user app.

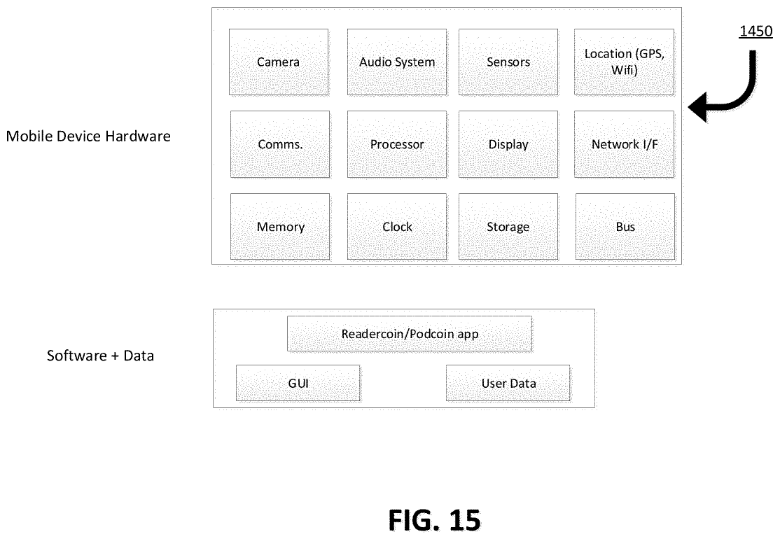

FIG. 15 is a block diagram depicting the hardware components of the mobile user device, and the software and data components of the inventive mobile user app, which we call the “Readercoin” app or the “Podcoin” app. FIG. 15 illustrates several components of an exemplary user device 1450 in accordance with one embodiment. In various embodiments, user device 1450 will preferably include a mobile device, such as a smartphone, but may also include a desktop PC, workstation, laptop, tablet, appliance, or other computing device that is capable of performing operations such as those described herein. In some embodiments, user device 1450 may include many more components than those shown in FIG. 15. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware. In FIG. 15, we show the mobile device hardware components separately from the components of the “Readercoin” app and “Podcoin” app.

As shown, the hardware components include a processor, memory, clock, and storage, as well as a camera, audio system (including an audio output for headphones/earbuds), sensors, and a location subsystem (e.g., a GPS or Wi-Fi based location system). The components of the “Readercoin” app and “Podcoin” app include the software and data to enable the incented platform as discussed herein.

In various embodiments, user device 1450 may comprise one or more physical and/or logical devices that collectively provide the functionalities described herein. In some embodiments, user device 1450 may comprise one or more replicated and/or distributed physical or logical devices. In some embodiments, the user device 1450 may comprise one or more computing resources provisioned from a “cloud computing” provider. In addition, a typical user device 1450 will include a bus interconnecting several components including a network interface, display, central processing unit, and a memory. The memory generally comprises a random access memory (“RAM”), and the storage generally comprises a permanent non-transitory mass storage device, such as a hard disk drive or solid-state drive. An operating system (not shown) will also be present in memory.

Monetization Scheme

Various systems and methods include a monetization aspect. In an example, a “promoted episode” may be provided at the top of the display, e.g., Discover tab. Podcasters can purchase listening hours via a website, e.g., https://bonus.podcoin.com. In an exemplary embodiment, the platform will leverage third part integrations, e.g., Stripe, for credit card and Paypal processing.

The following provides a scheme for earning a promoted podcast. An administrator of an account may set a variable to set the Promoted Episode Earning Rate. In an example, if the Rate is set to 2, that means it earns at 2 podcoins—or other currency—per predetermined time period, e.g., 10 min, for normal, and 3 podcoins per time (10 min) for a streak. If the Rate is set to 3, then 3 podcoins per time, (per 10 min) for normal and 4 podcoins per time (per 10) min for a streak.

Promoted episodes may be earned at the configured rate—but only for the episodes that are promoted—and not for any previous episodes. In examples, other non-promoted episodes of the same podcast may be earned at a “Bonus” rate for the length of time that a podcast is promoted, but not at the “Promoted” rate. This is true even for podcasts that are not set as “bonus” podcasts.

Once a Promoted Episode reaches its pre-set level of listening hours, then the Promoted Episode may be removed from the Promoted Episode placement and the rest of the episodes will earn at the prevailing “normal” rate and not the bonus rate. If at the end of the promoted-episode period the podcast is set to “bonus” then it will be at the “bonus” rate but otherwise it will be at the “normal” rate.

In examples, Promoted episodes may be earned earn at the higher rate until they achieve their target number of promoted hours. After achieving the target number of promoted hours it is expected that that episode will no longer earn at the higher rate. It is acceptable for this to take up to 30 min before the system realizes the threshold has been reached.

Episodes may also be promoted based on a particular episode placement, e.g., at the top of a Trending List. Selecting the promoted podcast may present an episode detail screen (EDS) and/or begin to play the podcast. In examples, up to 5 promoted episodes may be displayed every 3 min, although such times may be varied based on one or more considerations.

Episodes shown on this list may be displayed based on the following logic: (1) Select all episodes that match the podcast filter sorted by an ad rank score where adrank is >[adrank-score-minimum], wherein the [adrank-score-minimum] is configured in Admin (For example, it may be set to −30); (2) Show the Top 5 adrank score ads in order in the marquee and only query for more for a given user every 3 min. If an episode has been on screen before for that user, the adrank score may be decreased by 1. An ad is considered “on screen” if it is in the first position and screen is loaded or if it is swiped to.

In various examples, users can only promote a podcast they previously claimed. An Owner tab in the app may have a clear placement at the top. In some examples it may be next to a tab that states “Get More Listening Minutes”. User completes a form on mobile web, e.g., visiting bonus.podcoin.com, ad may log in automatically. In the user questionnaire, users may be asked questions including but not limited to:
Which podcast do you want to promote? [shows the claimed podcast tiles and titles for every episode]
[once a podcast is chosen] Which episodes do you want to promote? Select up to 5. [Shows the most recent 20 episodes with a checkbox next to each]
   If multiple episodes are chosen the listening hours may be split split evenly among them.
How many hours of listening to these episodes would you like? [user can select 100 hours to 10,000 hours; when user enters the number they see the cost. Cost will be 50 cents per hour.]
How many days would you like to spread the listening over?
What podcast subscribers do you want to target?
   Top choice: All subscribers
   Choose certain podcasts: This allows you to choose up to 30 podcasts to target certain users from the list of the Top 1000 podcasts by listening time.

In other aspects, users may pay for particular episodes, with the cost being visible upon submission of the form. Users may pay via credit card or other electronic payment. In embodiments, no credit card information is stored. Other monetization aspects include enabling bidding for hours (e.g., listening hours) rather than the flat per hour rate. In addition, a machine-learning algorithm may be implemented to show promoted episodes to users who are more likely to listen to them. In such embodiments, the selected episodes may be based on the users' past listening, search queries, interests, or other criteria.

Exemplary embodiments and examples of the above include systems and methods for computer-based distribution and incentivized consumption of long-form content. In an example, a system may comprise a server; a database communicatively coupled to the server, the database comprising a plurality of items of long-form content, wherein each item of long-form content in the plurality is associated with an author; a processor; and a memory communicatively coupled to the processor. In embodiments, the memory may store programmatic code such that, execution by the processor causes the computing system to at least: authenticate a connection from a user device to the server, wherein the user device is associated with a consumer of long-form content; obtain, from the user device, a selection comprising an item of long-form content that the consumer selects from the plurality of items of long-form content; establish a connection from an author device to the server, wherein the author device is associated with the author of the selection; display the selection on at least one of an audio interface and a graphical user interface of the user device; send a reward to the user device and to the author device when the consumer consumes the selection.

In embodiments, the plurality of items of long-form content may comprise at least one of an e-book, an audiobook, and a podcast. In addition the reward to the user device and to the author device may be sent when the consumer consumes the selection for a predetermined time period. In another example, a reward sent to the user device and the author device may comprise one Readercoin, or other currency, and in some examples, the predetermined time period may be one, five, ten minutes, or other predetermined time period.

In some embodiments, the programmatic code, when executed by the processor, can further cause the computing system to at least donate the reward sent to the user device or the reward sent to the author device to a charity. The reward sent to the user device or the reward sent to the author device can also be exchanged for cash, and/or donated, for example, to a crowdfunding project to support author projects. Similarly, a promoted item of long-form content selected from the plurality of items of long-form content may be displayed on the graphical user interface of the user device, and wherein the selection comprises the promoted item of long-form content and the computing system may send the reward to the user device and to the author device at a rate that is faster than a rate at which the computing system sends the reward to the user device and to the author device when the selection does not comprise the promoted item of long-form content. The reward may also be sent to the user device and to the author device at the rate that is faster than the rate at which the computing system sends the reward to the user device and to the author device when the selection does not comprise the promoted item of long-form content for a predetermined period of time.

What is claimed is:

1. A system for computer-based distribution and incentivized consumption of long-form content, the computing system comprising:
a server;
a database communicatively coupled to the server, the database comprising a plurality of items of long-form content, wherein each item of long-form content in the plurality is associated with an author;
a processor; and
a memory communicatively coupled to the processor, the memory storing programmatic code that, when executed by the processor, causes the computing system to at least:
authenticate a connection from a user device to the server, wherein the user device is associated with a consumer of long-form content;
obtain, from the user device, a selection comprising an item of long-form content that the consumer selects from the plurality of items of long-form content;
establish a connection from an author device to the server, wherein the author device is associated with the author of the selection;
display the selection on at least one of an audio interface and a graphical user interface of the user device;
send a reward to the user device and to the author device when the consumer consumes the selection.

2. The system of claim 1, wherein the plurality of items of long-form content comprises at least one of an e-book, an audiobook, and a podcast.

3. The system of claim 1, wherein the computing system sends the reward to the user device and to the author device when the consumer consumes the selection for a predetermined time period.

4. The system of claim 3, wherein the reward sent to the user device and the author device comprises one Readercoin and wherein the predetermined time period is ten minutes.

5. The system of claim 1, wherein the programmatic code, when executed by the processor, further causes the computing system to at least donate the reward sent to the user device or the reward sent to the author device to a charity.

6. The system of claim 1, wherein the programmatic code, when executed by the processor, further causes the computing system to at least exchange the reward sent to the user device or the reward sent to the author device for cash.

7. The system of claim 1, wherein the programmatic code, when executed by the processor, further causes the computing system to at least donate the reward sent to the user device to a crowdfunding project to support author projects.

8. The system of claim 1, wherein the programmatic code, when executed by the processor, further causes the computing system to at least display a promoted item of long-form content selected from the plurality of items of long-form content on the graphical user interface of the user device, and wherein the selection comprises the promoted item of long-form content and the computing system sends the reward to the user device and to the author device at a rate that is faster than a rate at which the computing system sends the reward to the user device and to the author device when the selection does not comprise the promoted item of long-form content.

9. The system of claim 8, wherein the computing system sends the reward to the user device and to the author device at the rate that is faster than the rate at which the computing system sends the reward to the user device and to the author device when the selection does not comprise the promoted item of long-form content for a predetermined period of time.

10. A method for computer-based distribution and incentivized consumption of long-form content, the method comprising:
authenticating a connection from a user device to a server, wherein the user device is associated with a consumer of long-form content;
obtaining, from the user device, a selection comprising an item of long-form content that the consumer selects from a database comprising a plurality of items of long-form content, wherein each item of long-form content in the plurality is associated with an author;
establishing a connection from an author device to the server, wherein the author device is associated with the author of the selection;
displaying the selection on at least one of an audio interface and a graphical user interface of the user device;
sending a reward to the user device and to the author device when the consumer consumes the selection.

11. The method of claim 10, wherein the plurality of items of long-form content comprises at least one of an e-book, an audiobook, and a podcast.

12. The method of claim 10, wherein sending the reward to the user device and to the author device when the consumer consumes the selection comprises sending the reward to the user device and to the author device when the consumer consumes the selection for a predetermined time period.

13. The method of claim 12, wherein the reward sent to the user device and the author device comprises one Readercoin and wherein the predetermined time period is ten minutes.

14. The method of claim 10, further comprising donating the reward sent to the user device or the reward sent to the author device to a charity.

15. The method of claim 10, further comprising exchanging the reward sent to the user device or the reward sent to the author device for cash.

16. The method of claim 10, further comprising donating the reward sent to the user device to a crowdfunding project to support author projects.

17. The method of claim 10, further comprising:
displaying a promoted item of long-form content selected from the plurality of items of long-form content on the graphical user interface of the user device, wherein the selection comprises the promoted item of long-form content; and
sending the reward to the user device and to the author device at a rate that is faster than a rate at the reward is sent to the user device and to the author device when the selection does not comprise the promoted item of long-form content.

18. The method of claim 17, wherein sending the reward to the user device and to the author device at a rate that is faster than a rate at the reward is sent to the user device and to the author device when the selection does not comprise the promoted item of long-form content comprises:
sending the reward to the user device and to the author device at a rate that is faster than a rate at the reward is sent to the user device and to the author device when the selection does not comprise the promoted item of long-form content for a predetermined period of time.

19. A computer-readable medium storing instruction that, when executed on a processor, cause a computing system to at least:
authenticate a connection from a user device to a server, wherein the user device is associated with a consumer of long-form content;
obtain, from the user device, a selection comprising an item of long-form content that the consumer selects from a database comprising a plurality of items of long-form content, wherein each item of long-form content in the plurality is associated with an author;
establish a connection from an author device to the server, wherein the author device is associated with the author of the selection;
display the selection on at least one of an audio interface and a graphical user interface of the user device;
send a reward to the user device and to the author device when the consumer consumes the selection.

20. The computer-readable medium of claim 19, further comprising instructions that, when executed on a processor, cause the computing system to at least:
display, on a graphical user interface of the user device, a promoted item of long-form content selected from the plurality of items of long-form content on the graphical user interface of the user device, wherein the selection comprises the promoted item of long-form content; and
send the reward to the user device and to the author device at a rate that is faster than a rate at the reward is sent to the user device and to the author device when the selection does not comprise the promoted item of long-form content.
